(19) United States
(12) Patent Application Publication
(10) Pub. No.: US 2020/0382622 A1
(43) Pub. Date: Dec. 3, 2020

(54) METHODS AND SYSTEMS FOR PROVIDING COMMUNICATION BETWEEN REGULATING DEVICES AND SENSING DEVICES

(71) Applicant: Carrier Corporation, Palm Beach Gardens, FL (US)

(72) Inventor: Ramakrishna Gattu, Hyderabad (IN)

(21) Appl. No.: 16/880,454

(22) Filed: May 21, 2020

(30) Foreign Application Priority Data
May 30, 2019 (IN) 201911021527

(51) Int. Cl. H04L 29/06; H04L 29/08

(52) U.S. Cl. CPC H04L 67/42; G16Y 40/10; H04L 67/12

(57) ABSTRACT

Aspects of the invention are directed towards methods and systems for providing communication between remote regulating device/s and sensing device/s through a server. One or more embodiments of the invention describe receiving one or more parameters sensed by sensing devices in a given area via a first communication channel. One or more embodiments of the invention further describe transmitting the sensed parameters to a remote regulating device via a second communication channel. Furthermore, the embodiments of the invention also describe that the remote regulating device processes the sensed parameters and transmit signals to one or more actuators for controlling the one or more parameters of the given area based on a preconfigured information.

### FOREIGN PRIORITY

This application claims priority to Indian Patent Application No. 201911021527, filed May 30, 2019, and all the benefits accruing therefrom under 35 U.S.C. § 119, the contents of which in its entirety are herein incorporated by reference.

### TECHNICAL FIELD OF INVENTION

The present invention relates generally to wireless communication. More particularly, the invention relates to systems and methods for providing communication between one or more sensing devices and a remote regulating device.

### BACKGROUND OF THE INVENTION

With the advancement in the technology, one or more sensors have been developed which can be installed in various rooms of a home or an office space. Such sensors are useful for monitoring environmental parameters (such as temperature, smoke, gases, humidity, occupancy, fire, air quality etc.) in the home or the office. These sensors can be connected with a regulating device which, in turn, controls/regulates the environmental parameters in the home or office. Specifically, the sensors measure the environmental parameters in the rooms and transmit such measurement of the environmental parameters to the regulating device (say a thermostat) via short-range wireless communication like Bluetooth, ZigBee etc. In other words, the sensors installed in the various rooms, and thermostat communicate with each other through the Bluetooth or ZigBee communication.

Currently, in order to communicate through the short-range wireless communication, the sensors and the regulating devices need to be in proximity with each other. Such proximity defines a range or a limit for each of the devices to operate. For instance, the sensors and the thermostat operate within the range of 45-50 feet. Beyond such range, the sensors and the thermostat fail to communicate with each other and thus, become inoperable. Particularly, when the regulating device is installed on a ground floor of a building and the sensors are installed on a second floor or a third floor of the same building, then the sensors and the regulating devices do not fall within the prescribed or allowable range of the short-range wireless communication.

In such a situation, the sensors are unable to transmit measurements of the environmental parameters to the regulating device and thus, the regulating device fails to control/regulate the environmental parameters. This failure in regulation/control of the environmental parameters in the rooms may lead to unwanted circumstances and may cause harm to people present in the room.

In view of afore-mentioned problems in the existing solutions with short-range communication between the sensors and the regulating device, there is a need of efficient and effective systems and methods for providing communication when the sensors and the regulating device are significantly spaced apart, say beyond the range of 45-50 feet or beyond the short-range communication. There is also a need for enabling the sensors and the thermostat to communicate with each other without any failure. In order to solve the problems in the existing solutions, systems and methods are disclosed for enabling communication between the sensors and a remote regulating device through a server.

### SUMMARY OF THE INVENTION

Various embodiments of the invention describe systems and methods for enabling communication between a plurality of sensing devices and a remote regulating device through a server. The invention discloses a system for enabling communication between sensing devices and a remote regulating device through a server. The plurality of sensing devices are configured to sense one or more parameters in a given area. The sensing devices transmit the sensed parameters to the server via a communication channel. The system also comprises the server which is configured to receive the sensed parameters from the sensing devices and transmit the sensed parameters to the remote regulating device. Particularly, the sensed parameters are transmitted to the server periodically or based on an event. Further, the remote regulating device is further configured to process the sensed parameters and to transmit signals to one or more actuators for controlling the one or more parameters of the given area based on a preconfigured information.

In another embodiment of the invention, wherein the plurality of sensing devices are integrated with a narrow-band internet of thing (NB-IoT) module or category M1 (CAT-M1) module for communication with the server using the communication channel.

In another embodiment of the invention, the one or more parameters are associated with the plurality of sensing devices and the one or more actuators.

In yet another embodiment of the invention, the preconfigured information may be a pre-defined threshold set by a user either through an interface of the remote regulating device or either through an interface of an application. Such preconfigured information is set for the sensed parameters and to control these parameters in the given area.

In still another embodiment of the invention, the sensing devices are provisioned with the remote regulating device by defining a unique identifier and a location for each sensing device in the remote regulating device.

In an embodiment, the remote regulating device may be a thermostat.

In another embodiment, the sensing devices transmit sensed parameters to the server using a first communication channel and the remote regulating device receives sensed parameters from the server using a second communication channel. In another embodiment, the remote regulating device receives sensed parameters from the server over a Wi-Fi network. In a different another embodiment, the sensed parameters are transmitted to the remote regulating device via a NB-IoT gateway.

In another different embodiment, the NB-IoT gateway further comprises an NB-IoT modem for receiving the sensed parameters from the server and a short-range transceiver to transmit the sensed parameters to the regulating device.

In yet another different embodiment, the short range transceiver includes one of a Bluetooth transceiver, a Wi-Fi transceiver, or a ZigBee transceiver.

In yet another embodiment of the invention, a method is disclosed for receiving one or more parameters sensed by the plurality of sensing devices in a given area via a first communication channel. The one or more parameters are sensed by the sensing devices and the sensed parameters are transmitted to a server through the first communication channel. In turn, the server transmits the sensed parameters to a remote regulating device via a second communication channel. Further, the remote regulating device processes the sensed parameters and transmits signals to one or more actuators for controlling the one or more parameters of the given area based on a preconfigured information. The first communication channel corresponds to a narrow-band internet of thing (NB-IoT) channel or category M1 channel. Further, the second communication channel corresponds to a narrow-band internet of thing (NB-IoT) channel, a category M1 channel or a Wi-Fi communication channel.

In another embodiment of the invention, the one or more parameters are associated with the plurality of sensing devices and the one or more actuators.

In yet another embodiment of the invention, the sensed parameters are transmitted from the server to the remote regulating device via a NB-IoT gateway.

In still another embodiment of the invention, the sensed parameters are transmitted from the sensing devices to the server periodically or based on an event.

In another embodiment of the invention, the one or more parameters include at least one of a temperature, smoke, fire, gas, humidity, occupancy detection or air quality level.

In different embodiments of the invention, the preconfigured information may be a pre-defined threshold set by a user either through an interface of the remote regulating device or either through an interface of an application. Such preconfigured information is set for the sensed parameters and to control these parameters in the given area.

In various other embodiments of the invention, a computer readable medium is disclosed comprising one or more processors and a memory coupled to the one or more processors. The memory stores instructions which are executed by the one or more processors to receive one or more parameters sensed by sensing devices in a given area via a first communication channel and transmit the sensed parameters to a remote regulating device via a second communication channel. Further, the remote regulating device processes the sensed parameters and transmits signals to one or more actuators for controlling the one or more parameters of the given area based on a preconfigured information.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is an exemplary system architecture according to an exemplary first embodiment of the invention.

FIG. 2 is an exemplary system architecture according to an exemplary second embodiment of the invention.

FIG. 3 is an exemplary system architecture according to an exemplary third embodiment of the invention.

FIG. 4 is an exemplary block diagram of different components in a NB-IoT gateway according to an exemplary embodiment of the invention.

FIG. 5 is an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with systems, methods, and devices for enabling communication between a remote regulating device and one or more sensing devices through a server.

As used herein, the server has some processing capabilities and may also communicate with the remote regulating device via a second communication channel and the one or more sensing devices via a first communication channel. There may be a cloud storage, a remote database, or any such storage known in the art. The first communication channel corresponds to a narrow-band internet of thing (NB-IoT) channel, or a category M1 channel. And, the second communication channel corresponds to a narrow-band internet of thing (NB-IoT) channel, a category M1 channel or a Wi-Fi communication channel.

As used herein, the remote regulating device may refer to any device that is capable of remotely processing one or more sensed parameters and transmitting signal/s to actuator/s for controlling the sensed parameters. Such regulating device may include, a processor, a memory, a display, an input means, and any such component known in the art. The remote regulating device may be connected with a cellular network or a Wi-Fi network. The remote regulating device may communicate with the server through one of the cellular communication channel using the cellular network or WiFi communication channel using the Wi-Fi network. Such remote regulating device may be a thermostat or any such device known in the art.

As used herein, the one or more sensing devices may refer to sensor/s that possess capability of sensing/monitoring the one or more parameters in the area/building. Such sensing devices may also have the capability of communicating with the server via the first communication channel. As the name suggests, these sensors uses a 200 KHZ narrow-band of a GSM network for communicating with a cellular tower. Also, these sensors transmit data to the cellular tower on a time-to-time basis, which in turn sends the data to the server. Also, the sensing devices can be installed at various locations in the area/building. The one or more sensing devices may include, but not limited to, a temperature sensor, a gas sensor, a smoke sensor, a humidity sensor, fire sensor, air quality sensor, occupancy detector or any such sensor that is obvious to a person skilled in the art.

As used herein, the one or more parameters which are to be monitored by the one or more sensing devices may include, but not limited to, temperature, smoke, gas, fire, humidity, air quality level or any such parameter that is known in the art.

As used herein, the cellular network may refer to a Global System for Mobile (GSM) network, Long-Term Evolution (LTE) network, a code-division multiple access (CDMA) network or any such network that is known in the art.

As used herein, the Wi-Fi network may refer to a network based on IEEE 802.11 Standards and provided by a WiFi access point. Such network provides coverage within a specified limit.

Throughout the specification, reference numeral 114 depicts a sensing device. The reference numeral 114A, 114B, 114C . . . 114N may be considered as one or more sensing devices.

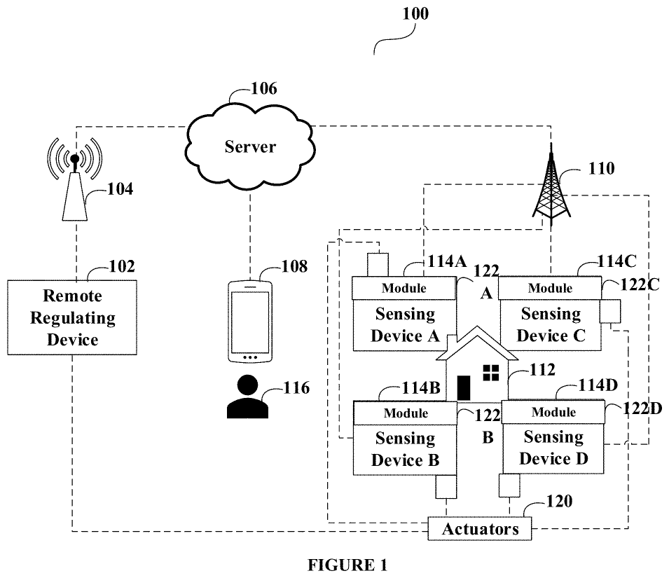

FIG. 1 depicts a system architecture 100 for enabling communication between a remote regulating device 102 and one or more sensing devices 114 through a server 106, according to an exemplary first embodiment of the invention. As depicted in FIG. 1, the remote regulating device 102 is connected with a Wi-Fi access point 104. In another embodiment, the remote regulating device 102 is a thermostat. The one or more sensing devices 114 are connected with a cellular tower 110 that provides cellular network to the one or more sensing devices 114. The one or more sensing devices 114 communicate with the server 106 via a first communication channel. In an embodiment, the first communication channel is the cellular network accessed via the cellular tower 110. Likewise, the remote regulating device 102 communicates with the server 106 via a second communication channel. In an embodiment, the second communication channel is through a wireless network provided by the Wi-Fi access point 104. In another embodiment, the server may be accessible by the remote regulating device 102 via a cellular communication channel, where the remote regulating device 102 includes a sensing device 114 to communicate with the server 106. Further, the server 106 is accessible by a user 116 using an application installed on a user equipment 108. The application is made specifically for accessing the information associated with remote regulating device 102 and/or the sensing devices 114, wherein the information is stored in the memory of the server 106. Furthermore, as shown in the FIG. 1, the one or more sensing devices 114 and one or more actuators 120 are located/installed in a home/building 112.

The one or more sensing devices may be integrated with a module with cellular communication. The module can be a NB-IoT module to enable a NB-IoT communication. Similarly, the other cellular technologies like category M1 modules can be used to enable communication between the sensing devices and the server.

The user equipment 108 can be a desktop computer or a hand held device such as a mobile phone with at least a display, a processor, a storage unit and with network connectivity. Example of the user equipment includes a desktop, workstation PC, a laptop, a smart phone, a tablet, a wearable device and the like.

Moreover, the one or more sensing devices 114 are provisioned with the remote regulating device 102 by defining a unique identifier, a security key and/or a location associated with the one or more sensing devices 114. Such information associated with the one or more sensing devices 114 is inputted in the remote regulating device 102 by the user. In one embodiment, the user may input such information associated with the one or more sensing devices 114 using the application. As an alternative embodiment, the user may input such information associated with the one or more sensing devices 114 using an interface of the remote regulating device 102. In another embodiment, the information associated with the one or more sensing devices 114 is/are provided to the remote regulating device 102 by scanning a bar code available on the one or more sensing devices 114.

An exemplary Table 1 below is specified herein to demonstrate the exemplary functioning of the remote regulating device 102 and the one or more sensing devices 114. For an instance, the sensing device 114A is located in a bedroom of a first floor of a home 112 and the sensing device 114C is located in a lounge of a second floor of the home 112. Also, the sensing device 114B is located in a bedroom of a third floor of the home 112 and the sensing device 114D is located in a bedroom of a fourth floor of the home 112. The remote regulating device 102 is configured to control sensed parameters for all the sensing devices 114A, 114B, 114C, 114D.

Exemplary Table 1

| Regulating device | Sensing devices | |
|---|---|---|
| Name/Identifier | Name/Identifier | Location |
| Regulating Device 102 | Sensing device 114A | Bedroom, First Floor |
| | Sensing device 114C | Lounge, Second Floor |
| | Sensing device 114B | Bedroom, Third Floor |
| | Sensing device 114D | Bedroom, Fourth Floor |

In an exemplary embodiment, the remote regulating device 102 transmits an instruction/command to the server 106 for initiating monitoring of the one or more parameters. In an embodiment, the instruction/command is provided by the user 116 using the interface of the remote regulating device 102. In another embodiment, the instruction/command can be initiated automatically at a preconfigured time. In an alternative embodiment, the instruction/command is provided by the user 116 using the application installed in the user equipment 108. Such instruction is transmitted to the server 106 using the Wi-Fi network provided by the Wi-Fi access point 104 (i.e. via the second communication channel). On receiving the instruction/command from the remote regulating device 102, the server 106 transmit the instruction/command to the one or more sensing devices 114. Subsequently, each of the sensing devices 114 initiate monitoring the one or more parameters. After a pre-defined period of time, the one or more sensing devices 114 transmits sensed parameters to the server 106 via the first communication channel. Such pre-defined period of time can be configured by the user 116 and the sensed parameters may be transmitted in one of a periodic manner and an event-based manner. For instance, the user 116 can configure a period of 1 hour after which the one or more sensing devices 114 transmits the sensed parameters to the server 106. Alternatively, the user 116 can configure an event on occurrence of which the one or more sensing devices 114 transmits the sensed parameters to the server 106. For e.g. whenever the temperature breaches a predefined limit as specified by the user 116. As used herein, the sensed parameters includes one of a value, a range, a percentage, and an indicator corresponding to the one or more parameters. Also, the one or more parameters are associated with the one or more of sensing devices 114 and the one or more actuators 120.

When the server 106 receives the sensed parameters from the one or more sensing devices 114, the server 106 in turn transmits the sensed parameters to the remote regulating device 102 via the second communication channel for processing the sensed parameters. And, the regulating device 102 transmits signals to one or more actuators 120 for controlling the sensed parameters of the given area based on a preconfigured information. In one exemplary embodiment, the remote regulating device 102 compares the sensed parameters with the preconfigured information of a particular parameter. In an event, the value of sensed parameters reaches above the preconfigured information, the remote regulating device 102 decreases the sensed parameter with respect to the preconfigured information by issuing appropriate signal to the actuator 120. In another event, when the value of sensed parameter reaches below the preconfigured information, the remote regulating device 102 increases the sensed parameter with respect to the preconfigured information. Broadly, the remote regulating device 102 regulates/controls the sensed parameters. Such controlling of the sensed parameters by the remote regulating device 102 is performed by transmitting signals to one or more actuators 120 for controlling the one or more parameters of the given area/room where the sensor is located/installed. In an embodiment, the sensing device can detect occupancy of an area and accordingly, the regulating device may issue instructions.

Exemplary Table 2

| | Pre- | | | |
|---|---|---|---|---|
| | configured | | Current | |
| | Information | | Temperature | |
| Regulating | (such as | | (in ° C.) sensed | |
| device | Temperature | Sensing device | by Sensing | |
| Name/Identifier | in ° C.) | Name/Identifier | device | Location |
| Regulating Device 102 | 21 | Sensing device 114A | 21 | Bedroom, First Floor |
| | 16 | Sensing device 114C | 25 | Lounge, Second Floor |
| | 21 | Sensing device 114B | 16 | Bedroom, Third Floor |
| | 18 | Sensing device 114D | 18 | Bedroom, Fourth Floor |

In the exemplary Table 2 above, the sensing devices 114A, 114B, 114C and 114D sense the temperature parameter in the different rooms at different floors of the building. For an instance, the sensing device 114A senses/monitor the temperature in the bedroom of the first floor of the home 112. The current measurement of the temperature parameter is 21° C. as sensed by the sensing device 114A. Similarly, the sensing device 114C senses/monitors the temperature in the lounge of the second floor of the home 112. The current measurement of the temperature parameter is 25° C. as monitored by the sensing device 114C. Now, these sensed temperature parameter are sent to the server 106 via the first communication channel (using the cellular network) which in turn transmits the sensed temperature parameter to the remote regulating device 102 via the second communication channel (using the WiFi network). Now, the regulating device 102 compares the sensed temperature parameter with the pre-configured information configured by the user 116 for the bedroom of the first floor and the lounge of the second floor. In this case, the pre-configured information for the bedroom of the first floor is 21° C. and the pre-configured information for the lounge of the second floor is 16° C. The regulating device 102 compares the sensed temperature (i.e. 21° C.) with the pre-configured information for the bedroom of the first floor (21° C.). In such scenario, the regulating device 102 finds that sensed temperature in the bedroom of the first floor is same as the pre-configured information for the bedroom of the first floor, thus, the regulating device 102 does not transmit any signal to the actuators 120 for controlling the value of the sensed temperature being maintained in the bedroom of the first floor. In the other scenario for the sensing device 114C, the regulating device 102 transmits a signal to the actuators 120 for decreasing/reducing the current temperature by 9° C. since the pre-configured information for the lounge of the second floor is 16° C. Inn a similar manner, the regulating device 102 transmits a signal to the actuators 120 for increasing the current temperature of the bedroom at the third floor by 5° C. as the pre-configured information for this room is 21° C. as monitored by the NB-IoT 114B.

Moreover, the present invention encompasses the one or more sensing devices 114 to periodically transmit an update for the sensed parameters to the server 106 via the first communication channel. The server 106 transmits update for the sensed parameter to the remote regulating device 102 via the second communication channel for controlling the sensed parameters.

The present invention also encompasses the server 106 to transmit a firmware upgrade to the one or more sensing devices 114. The server 106 receives such firmware upgrade from the remote regulating device 102 or from the user equipment 108. By using the unique identifier of the relevant sensing device 114, the firmware can be upgraded.

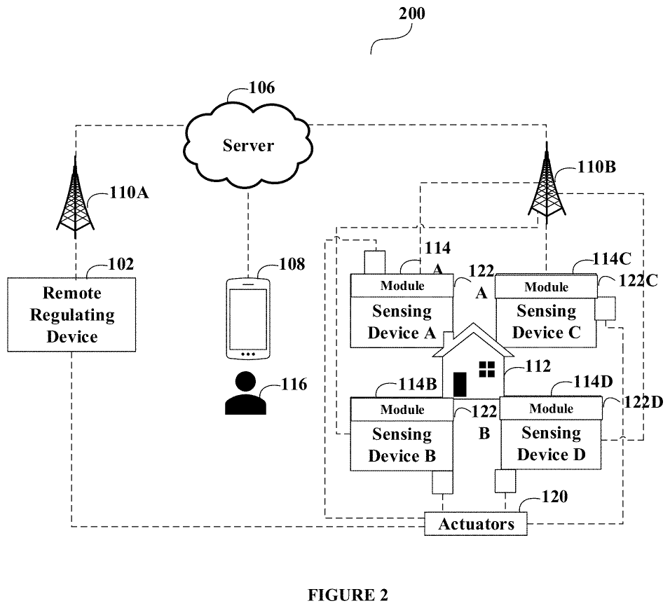

FIG. 2 depicts a system architecture 200 for enabling communication between the remote regulating device 102 and the one or more sensing devices 114 through the server 106, according to an exemplary second embodiment of the invention. As depicted in FIG. 2, the remote regulating device 102 communicates with the server 106 via the second communication channel. In this exemplary second embodiment and as seen in FIG. 2, the second communication channel between the remote regulating device 102 and the server 106 is through a cellular network provided by a cellular tower 110A. Also, the one or more sensing devices 114 communicates with the server 106 via the first communication channel. The first communication channel between the one or more sensing devices 114 and the server 106 is through a cellular network provided by a cellular tower 110B. In this exemplary second embodiment, both of the remote regulating device 102 and the one or more sensing devices 114 communicate with the server 106 using the cellular network provided by the respective cellular tower 110A/110B. Rest of the functioning of the present invention remains the same as described in details above in FIG. 1. Although as depicted in the FIG. 2, the remote regulating device 102 and the one or more sensing devices 114 communicate with each other (through the server 106) by using different cellular networks as provided by different cellular towers 110A, 110B respectively; however, it is also appreciated by a person skilled in the art that the remote regulating device 102 and the one or more sensing devices 114 may communicate with each other using the same cellular network provided by the same cellular tower.

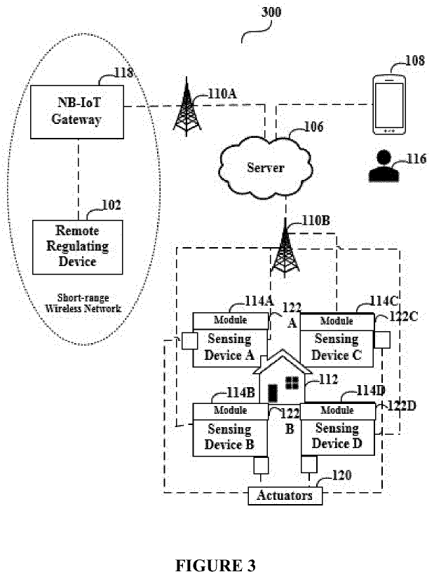

FIG. 3 depicts a system architecture 300 for enabling communication between the remote regulating device 102 and a NB-IoT gateway 118 through the server 106, according to an exemplary third embodiment of the invention. As depicted in FIG. 3, the remote regulating device 102 is connected with the NB-IoT gateway 118 through a short-range wireless network. The remote regulating device 102 communicates with the NB-IoT gateway 118 through the short-range wireless network. Such short-range wireless network may be a personal area network such as a bluetooth network, a WiFi network, a near-field network, or a ZigBee network. Further, the NB-IoT gateway 118 is connected with the server 116 through a cellular network provided by the cellular tower 110A. The server 116 is connected with one or more sensing devices 114 through a cellular network provided by the cellular tower 110B.

Further, the one or more sensing devices 114 initiate monitoring/sensing the one or more parameters and also transmit sensed parameters to the server 106 through the cellular network provided by the cellular tower 110B. Then, the NB-IoT gateway 118 using the cellular network provided by the cellular tower 110A collects the sensed parameters from the server 106 and transmits the sensed parameters to the remote regulating device 102 using the short-range wireless network which subsequently processes the one or more sensed parameters and transmit signal to the actuator/s 120 as discussed above. Although as depicted in the FIG. 3, the NB-IoT gateway 118 and the one or more sensing devices 114 communicate with each other (through the server 106) by using different cellular networks as provided by different cellular towers 110A, 110B respectively; however, it is also appreciated by a person skilled in the art that the NB-IoT gateway 118 and the one or more sensing devices 114 may be communicate with each other using the same cellular network provided by same cellular tower.

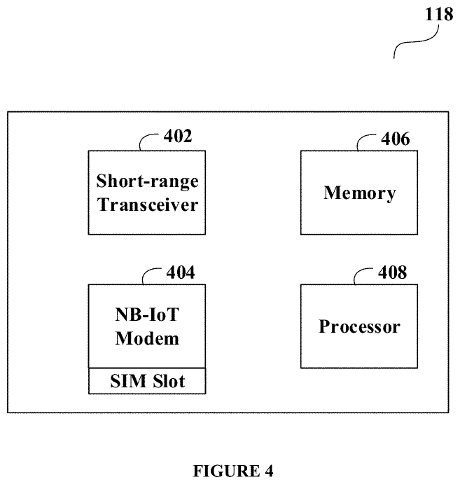

FIG. 4 depicts the exemplary block diagram of various components of the NB-IoT gateway 118, according to an embodiment of the invention. The NB-IoT gateway 118 comprises, but is not limited to, a short-range transceiver 402, an NB-IoT modem 404, a memory 406 and a processor 406. The short-range transceiver 402 further includes, but is not limited to, a bluetooth transceiver, a Wi-Fi transceiver, and a ZigBee transceiver. The NB-IoT modem 404 is configured to receive the sensed parameters from the server 106 through the cellular network. The NB-IoT modem may include a sim card slot to enable cellular communication. The short-range transceiver 402 is configured to transmit the sensed parameters to the remote regulating device 102 using the short-range network. The memory 406 is communicatively coupled with the processor 408 and is configured to store details of the one or more sensing devices 114 as well as the details of the remote regulating device 102. The functioning of the NB-IoT gateway 118 is discussed in FIG. 3.

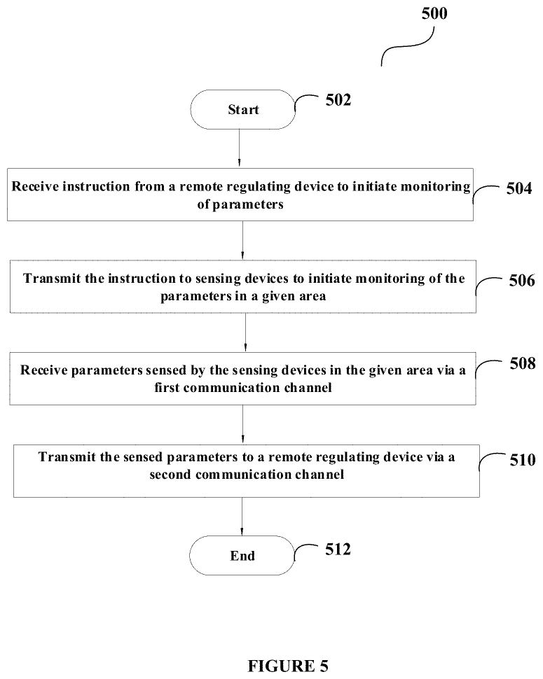

FIG. 5 depicts a flowchart outlining the features of the invention in an exemplary embodiment of the invention. The method flowchart 500 describes a method being performed for enabling the invention. The method flowchart 500 starts at step 502.

At step 504, the server 106 receives the instruction/command from the remote regulating device 102 to initiate sensing/monitoring of the one or more parameters. In an embodiment, the instruction/command is provided by the user 116 using the interface of the remote regulating device 102. In another embodiment, the instruction/command can be initiated automatically at a preconfigured time. In an alternative embodiment, the instruction/command is provided by the user 116 using the application installed in the user equipment 108. Such instruction is transmitted to the server 106 using the WiFi network or the cellular network.

At step 506, the server 106 transmits the instruction/command to the one or more sensing devices 114 on receiving the instruction/command from the remote regulating device 102. Subsequently, each of the sensing devices 114 initiate sensing/monitoring the one or more parameters.

At step 508, the server 106 receives the sensed parameter from the one or more sensing devices 114 after a pre-defined period of time. Such pre-defined period of time can be configured by the user 116 in one of a periodic manner and an event-based manner. The one or more sensing devices 114 communicates with the server 106 via the first communication channel. In another embodiment, the first communication channel is through the cellular network provided by the cellular tower 110.

At step 510, the server 106 transmits the sensed parameter to the remote regulating device 102 for processing the one or more sensed parameters via the second communication channel. In particular, the remote regulating device 102 processes the sensed parameter based on the pre-configured information. In an event, the remote regulating device 102 finds that the sensed parameter reaches above the pre-configured information, the remote regulating device 102 transmits a signal to the actuator 120 for decreasing the value of sensed parameter with respect to the pre-configured information. In another event, when the sensed parameter reaches below the pre-defined threshold, the remote regulating device 102 transmits a signal to the actuator 120 for increasing the value of sensed parameter with respect to the pre-configured information. The method flowchart ends at 512.

The present invention is applicable in various fields such as, but not limited to, heating, ventilation, and air conditioning (HVAC) systems, smart metering systems, facility management services, intruder and fire alarm systems, connected personal appliances, tracking of person/animal/object, smart city infrastructure, connected industrial appliances (like welding machine, air compressors), healthcare, residential area, a building, commercial buildings, and any such field that is obvious to a person skilled in the art.

The present invention provides the following technical advantages over the existing methods and systems where the legacy thermostats with just Wi-Fi (and not BLE or other PAN radios) can support wireless remote room sensing with sensing device: a) Enable communication between the remote regulating device 102 and the one or more sensing devices 114 without any proximity/distance limitation, b) Usage of the cellular network by the remote regulating device 102 and/or the one or more sensing devices 114 for communicating with each other, c) Usage of the server 106 as a communication medium between the remote regulating device 102 and the one or more sensing devices 114, d) Usage of the server 106 for communicating the instruction and/or the sensed parameter between the remote regulating device 102 and the one or more sensing devices 114, and e) Usage of the one or more sensing devices 114 as the Narrow-band Internet of things (NB-IOT) devices by integrating the NB-IoT communication unit for minimal battery requirement and very less payloads.

The embodiments of the invention and the tables discussed herein are exemplary and various modification and alterations to a person skilled in the art are within the scope of the invention.

In one embodiment of the invention, the invention can be operated using the one or more computer readable devices. The one or more computer readable devices can be associated with the server 106. The computer readable medium is configured to receive parameters sensed by sensing devices 114 in the given area via the first communication channel. The first communication channel is the cellular communication channel using the cellular network. The computer readable medium is further configured to transmit the sensed parameters to the remote regulating device 102 via the second communication channel. The second communication channel is either the cellular communication channel through the cellular network or the WiFi communication channel through the WiFi network. The remote regulating device 102 receives the sensed parameters and processes the sensed parameters. Based on the processing of the sensed parameters, the remote regulating device 102 transmit signals to the one or more actuators 120 for controlling the one or more parameters of the given area based on the preconfigured information.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”. The dashed lines in the figures represents the wireless communication between remote regulating devices, sensing devices, NB-IoT gateways and server.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system comprising:
a plurality of sensing devices to sense one or more parameters in a given area, the sensing devices transmitting the sensed parameters to a server via a communication channel;
the server configured to receive the sensed parameters from the sensing devices and transmit the sensed parameters to a remote regulating device; and
the remote regulating device configured to process the sensed parameters and transmit signals to one or more actuators for controlling the one or more parameters of the given area based on a preconfigured information.

2. The system as claimed in claim 1, wherein the plurality of sensing devices are integrated with a narrow-band internet of thing (NB-IoT) module or category M1 (CAT-M1) module for communication with the server using the communication channel.

3. The system as claimed in claim 1, wherein the one or more parameters are associated with the plurality of sensing devices and the one or more actuators.

4. The system as claimed in claim 1, wherein the sensing devices are provisioned with the remote regulating device by defining a unique identifier and a location for each sensing device in the remote regulating device.

5. The system as claimed in claim 1, wherein the sensed parameters are transmitted to the server periodically or based on an event.

6. The system as claimed in claim 1, wherein the remote regulating device is a thermostat.

7. The system as claimed in claim 1, wherein the remote regulating device receives sensed parameters from the server using the communication channel.

8. The system as claimed in claim 1, wherein the remote regulating device receives sensed parameters from the server over a Wi-Fi network.

9. The system as claimed in claim 1, wherein the sensed parameters are transmitted to the remote regulating device via a NB-IoT gateway.

10. The system as claimed in claim 9, wherein the NB-IoT gateway comprises:
an NB-IoT modem for receiving the sensed parameters from the server; and
a short-range transceiver to transmit the sensed parameters to the regulating device.

11. The system as claimed in claim 10, wherein the short range transceiver includes one of a Bluetooth transceiver, a Wi-Fi transceiver, or a ZigBee transceiver.

12. The system as claimed in claim 1, wherein the one or more parameters include at least one of a temperature, smoke, fire, gas, humidity, or air quality level.

13. A method comprising:
receiving one or more parameters sensed by sensing devices in a given area via a first communication channel;
transmitting the sensed parameters to a remote regulating device via a second communication channel; and
wherein the remote regulating device processes the sensed parameters and transmits signals to one or more actuators for controlling the one or more parameters of the given area based on a preconfigured information.

14. The method as claimed in claim 13, wherein the one or more parameters are associated with the plurality of sensing devices and the one or more actuators.

15. The method as claimed in claim 13, wherein the first communication channel corresponds to a narrow-band internet of thing (NB-IoT) channel or category M1 (CAT-M1) channel.

16. The method as claimed in claim 13, wherein the second communication channel corresponds to a narrow-band internet of thing (NB-IoT) channel, a category M1 channel or a Wi-Fi communication channel

17. The method as claimed in claim 13, wherein the sensed parameters are transmitted to the remote regulating device via a NB-IoT gateway.

18. The method as claimed in claim 13, wherein the sensed parameters are transmitted to a server periodically or based on an event.

19. The method as claimed in claim 13, wherein the one or more parameters include at least one of a temperature, smoke, fire, gas, humidity, or air quality level.

20. A computer readable medium comprising one or more processors and a memory coupled to the one or more processors, the memory storing instructions which are executed by the one or more processors, the one or more processors configured to:
receive one or more parameters sensed by sensing devices in a given area via a first communication channel; and
transmit the sensed parameters to a remote regulating device via a second communication channel;
wherein the remote regulating device processes the sensed parameters and transmits signals to one or more actuators for controlling the one or more parameters of the given area based on a preconfigured information.
